(19) United States
(12) Patent Application Publication
(10) Pub. No.: US 2002/0177431 A1
(43) Pub. Date: Nov. 28, 2002

(54) Packet switched data service on a wireless network

(76) Inventors: Thomas E. Hamilton, Marlborough, MA (US); Simon Cavenett, Roswell, GA (US)

Correspondence Address: KENNETH F. KOZIK, Fish & Richardson P.C., 225 Franklin Street, Boston, MA, 02110-2804, US

(21) Appl. No.: 10/061,526

(22) Filed: Feb. 1, 2002

Related U.S. Application Data
(60) Provisional application No. 60/292,564, filed on May 22, 2001.

(51) Int. Cl. H04M 11/00

(52) U.S. Cl. 455/406; 455/422

(57) ABSTRACT

A method of providing packet switched data services on a wireless network is presented. The method of providing a sponsored packet switched data service in a wireless network including receiving a request for a sponsored packet switched data service from a user, determining a sponsor for the requested service in accordance with stored policies, determining a session billing in accordance with the stored policies, establishing a session between the user and the sponsor, and billing the sponsor on completion of the session.

### CROSS-REFERENCE TO RELATED APPLICATIONS

This application claims the benefit of U.S. Provisional Application No. 60/292,564 filed May 22, 2001, “Method for Sponsored Packet Switched Data Services on a Wireless Network”. This application is incorporated herein by reference.

### FIELD OF THE INVENTION

The present invention relates to packet switched data services on a wireless network.

### BACKGROUND OF THE INVENTION

With the growth of the Internet, a great deal of information and services are available to a network that can handle packet switched data in TCP/IP protocol. To provide a suitable bearer for packet switched data protocols, such as TCP ring protocol for multicast use (TCPRP), so-called second generation wireless systems support Circuit Switched Data (CSD). To overcome data rate limitations of CSD, a variation of CSD is available for Global System for Mobile communication (GSM) called High Speed Circuit Switched Data (HSCSD). HSCSD combines multiple individual channels (time slots) for an aggregate data transmission bearer. To enable the second generation networks to more optimally provide a bearer service for packet switched data, upgrade technologies such as the General Packet Radio System (GPRS) have been developed as an augmentation of the GSM system technology.

### SUMMARY

In an aspect, the invention features a method of providing a sponsored packet switched data service including receiving a request in a wireless network for a sponsored packet switched data service from a user, determining a sponsor for the requested service in accordance with stored policies, determining a session billing in accordance with the stored policies, establishing a session between the user and the sponsor, and billing the sponsor on completion of the session.

Embodiments may include one or more of the following.

The stored policies may include pre-arrangements between a network provider and sponsors of packet switched data services. The stored polices include factors and the factors may include a user identity, a user location, a time of day, a user class, a service provider class, network conditions, pre-agreement rules and/or governmental regulations.

The sponsor may be packet switched data service provider, an operator of the network, and/or a third party packet switched data service.

The wireless network may be a second generation wireless network. The wireless network may be a Global System for Mobile communication (GSM) network, and the GSM network may be General Packet Radio System (GPRS) enabled.

The wireless network may be a Time Division Multiple Access (TDMA) network, a Code Division Multiple Access (CDMA) network, Universal Mobile Telecommunications System (UMTS) network, a TETRA network, a Tetrapol network, A DECT network, an AMPS network, or a wireless local area network (WLAN). The wireless network may be a third generation wireless network.

In another aspect, the invention features a method of providing a sponsored packet switched data service in a General Packet Radio System (GPRS) enabled Global System for Mobile communication (GSM) network including receiving a request for a sponsored packet switched data service from a user, determining a sponsor for the requested service in accordance with stored policies, determining a session billing in accordance with the stored policies, establishing a session between the user and the sponsor, and billing the sponsor on completion of the session.

Embodiments may include one or more of the following.

The stored policies may include pre-arrangements between a network provider and sponsors of packet switched data services and may include factors. The factors may include a user identity, a user location, a time of day, a user class, a service provider class, network conditions, pre-agreement rules and/or governmental regulations.

The sponsor may be a packet switched data service provider, a network operator and/or a third party packet switched data service.

In another aspect, the invention features, in a General Packet Radio System (GPRS) enabled Global System for Mobile Communication (GSM) network, collecting call data records (CDRs) from a Serving GPRS support node in the network, sending the CDRs to a charging gateway in the network, and processing the CDRs for packet switched data into a single composite CDR stream in the charging gateway.

Embodiments may include one or more of the following.

Collecting may also include collecting CDRs from a GPRS support node. Processing may include augmenting the CDRs for packet switched data in a billing mediation node.

The single composite CDR stream may represent a user session.

In another aspect, the invention features a method of providing a sponsored packet switched data service including, in a GPRS enabled GSM network, receiving a request for a packet switched data service, selecting a service provider for the packet switched data service, connecting a session to the selected service provider, metering the session, and generating billing information from the metering.

Embodiments may include one or more of the following.

The request may be from a user. Selecting may also include authenticating access for the user to the service provider, determining whether the request is for the selected service provider, and/or determining authorization for the user to the selected service.

Metering may include monitoring the session between the user and the selected service provider.

Embodiments of the invention may have one or more of the following advantages.

A wireless network is capable of carrying packet switched data so that one or more packet switched data services on the network are sponsored by another for a user.

The method allows the user to transparently obtain and use the packet switched data services without charge or toll.

The sponsor can be the provider of the packet switched data services, the operator of the network, third parties or combinations thereof.

A selected service provider is identified as a sponsor and a connection between the user and service provider monitored to produce billing units. The wireless network operator charges the selected packet switched data service provider account with the billing units based upon network usage such as packet volume, user location, time of day, type of service provided, and user class over the duration of a session with the packet switched data service. The session may be monitored to determine information units that are based upon the usage of the data service.

The network operator may be selected to provide the service and is identified as the sponsor. The session between the user and service provider is monitored to produce billing units. The network operator charges an internal account with the billing units based upon network usage such as packet volume, user location, time of day, type of service provided, and user class over the duration of a session with the packet switched data service. Optionally, the session is monitored to determine information units that are based upon the usage of the data service.

### BRIEF DESCRIPTION OF THE DRAWINGS

FIG. 1 is a block diagram of a wireless network.

FIG. 2 is a flow diagram of sponsored packet switched data service process.

### DETAILED DESCRIPTION

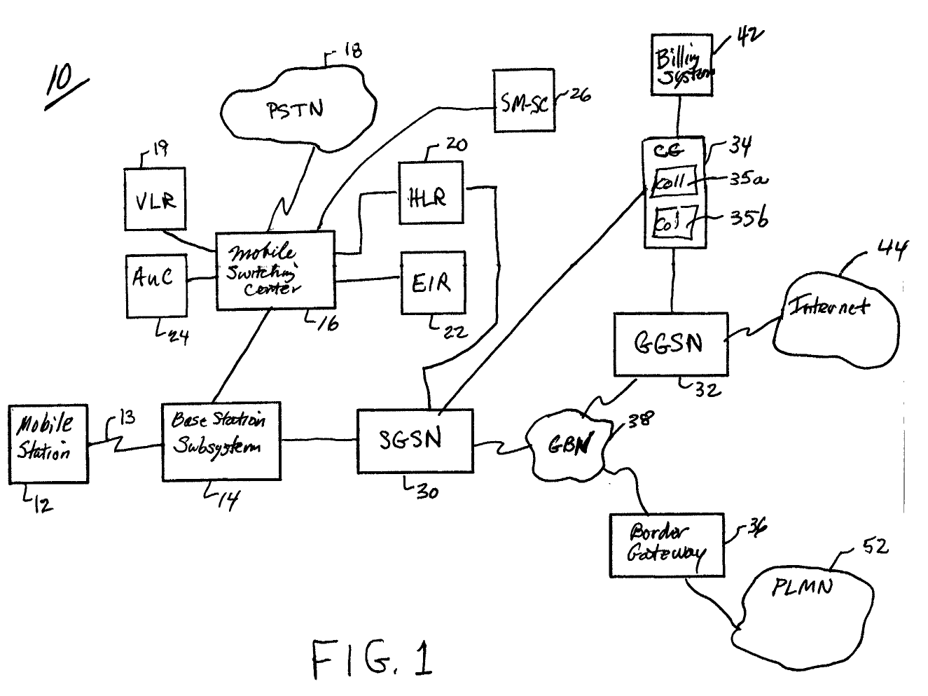

Referring to FIG. 1, a General Packet Radio System (GPRS) enabled Global System for Mobile communication (GSM) network 10 includes a Mobile Station (MS) 12. Although only one MS 12 is shown, the network 10 more typically includes a number of mobile stations. The MS 12 as commonly a digital telephone handset or other handheld digital device, such as a wireless enabled personal digital assistant (PDA).

The MS 12 communicates over an air interface 13 to a Base Station Subsystem (BSS) 14. The BSS 14 is responsible for controlling the air interface 13 operations of the network 10. The BSS 14 includes a Base Transceiver Station (BTS) and a Base Station Controller (BSC). The BTS is a radio transmitter/receiver and is located in its own cell or area of effect. The BTS has certain radio frequencies within a GSM band assigned to it. The BSC usually manages several BTSs and is the command and control for its dependent cells. Functions include radio channel allocation, call control and communications with a Mobile Switching Center (MSC) 16.

For circuit switched voice or data traffic, the BSC of the BSS 14 routes a circuit to the MSC 16. The MSC 16 routes traffic to an external network such as Public Switched Telephone Network (PSTN) 18 for land station-to-mobile station calls, mobile station-to-land station calls, or other mobile networks connected to the PSTN 18. The MSC 16 also manages authorization, authentication, and accounting functions for provided services.

The network 10 includes databases for enabling CSD services, e.g., a Visiting Location Register (VLR) 19, a Home Location Register (HLR) 20, an Equipment Identity Register (EIR) 22 and an Authentication Center (AuC) 24. The HLR 20 is a database (which can be distributed geographically) of all the subscribers on the network 10. The HLR 20 also includes information such as a current (or last known) handset where-abouts.

A complement of the HLR 20 is the VLR 19. Where as the HLR 20 is geographically distributed, and may not even be implemented at a particular MSC 16, it is usual for the VLR 19 to be located with each MCS 16. This greatly simplifies the routing of calls around the network 10. The network 10 also includes a Short Message Service Center (SM-SC) 26 that manages a short messaging service. The SM-SC 26 provides access and store-and-forward functions for short text/data messages in GSM, DCS, PCS, CDMA and D-AMPS mobile networks.

The network 10 further includes a Packet Control Unit (PCU)(not shown), a Serving GPRS Support Node (SGSN) 30, a Gateway GPRS Support Node (GGSN) 32, a Charging Gateway (CG) 34, Border Gateway (BG) 36, and a GPRS Backbone Network (GBN) 38.

The PCU, which is implemented as part of the BSS 14, provides a packet switched data interface for the circuit switched BSC of the BSS 14. The PCU also performs set up, supervision, and disconnection functions for packet switched calls. The PCU separates packet data and circuit-switched data when it is received from the MS 12 and multiplexes the different data streams from circuit-switched and packet-switched core networks into common streams going down to the cells.

The SGSN 30 interfaces between the GBN 38 and a radio portion of the network 10 and switches the data packets via GBN 38 to the correct BSS 14. The SGSN 30 performs, for packet switched services, ciphering and authentication, session management, mobility management, and logical link management through the network to Mobile Station 12. The SGSN 30 also communicates with the HLR 20.

The GGSN 32 is a gateway node between the GBN 38 and an external Packet Data Network (PDN), such as Internet 44. When the PDN is an external Internet Protocol (IP) network like the Internet 44, the GGSN 32 appears to the external IP network as an IP router serving an IP address of the Mobile Station 12. The GGSN 32 may include firewalling and packet filtering functions. The GGSN 32 also determines, for any external connection, the correct SGSN 30 to assign for any Mobile Station 12.

The SGSN 30 and the GGSN 32 register all possible aspects of a GPRS user's behavior and generate billing information accordingly. The billing information is gathered in Charging Data Records or Call Data Records (CDRs). CDRs may accumulate information based on a number of parameters, such as volume, duration, time, final destination, location, quality of service, SMS, served IMSI/subscriber, reverse charging, free of charge, flat rate, and bearer service.

The Border Gateway (BG) 36 is a gateway system between different Public Land Mobile Networks (PLMNs) 52. One purpose of BG 36 is to provide a secure connection over an inter-PLMN backbone network for packet switched data. The BG 36 virtually extends the GBN 38 to SGSNs that are physically located in different PLMNs 52 through connection to their BGs. Like the GGSN 32, the BG 36 appears as an IP router if the inter-PLMN network is an IP network. The BG 36 may also include security and firewalling functions.

A Charging Gateway (CG) 34 collects and processes all of the charging or billing information for the GPRS packet switched data handled by the network 10 in a collection process 35a. The collection process 35a collects charging information in the form of Call Detail Records (CDRs) from the SGSN 30 (referred as S-CDRs) and the GGSN 32 (referred to as G-CDRs) for all of the packet switched data. The S-CDRs from the SGSN 30 and the G-CDRs from the GGSN 32 are sent from the collection process 35a to a collation process 35b. The collation process 35b collates collected CDRs into a single composite CDR stream that is sent to a Billing System 42. The collation process 35b also processes the received CDR information to check for record duplication, information correlation, and validation.

In another example, the single composite CDR stream is sent through a Billing Mediation System (not shown) and then on to the Billing System 42.

In an example, the network 10 is utilized to provide a sponsored packet switched data service accessed by a user on a fully sponsored basis by another. Both the application based service (the content or user interactive service) and the network service (the packet data transport) are offered on a no charge, no toll basis to the user. Prior to using the service, the user is aware that by connection to the service that neither “air time” packet data transport charges or other content or usage service charges will apply. Optionally, the user may be notified at the time of requesting a service that it is sponsored.

A network operator manages and controls the sponsored packet switched data services, which includes any and all unique network addresses that identify the packet switched data service, the policy decisions that determine how, and to which, packet switched data service provider the user is directed, and the policy decisions that determine which sponsor is to be billed for the session and on what basis. The policy decisions for selection and billing may include rules that incorporate pre-agreements between the operator and third parties, either sponsors or service providers, as to the selection of the service provider and the method and basis of payment for the sponsor. A policy decision of which service provider to make a connection to may be made at the time of the service request based upon such factors as a user identity, a location of the user, a time of day, a user class, a service provider class, network conditions, pre-agreement rules, and/or governmental regulations. For example, a policy decision of which sponsor to bill and on what basis can be made at time of the service request based upon similar factors such as the user identity, the location of the user, time of day, user class, service provider class, network conditions, pre-agreement rules, and/or governmental regulations.

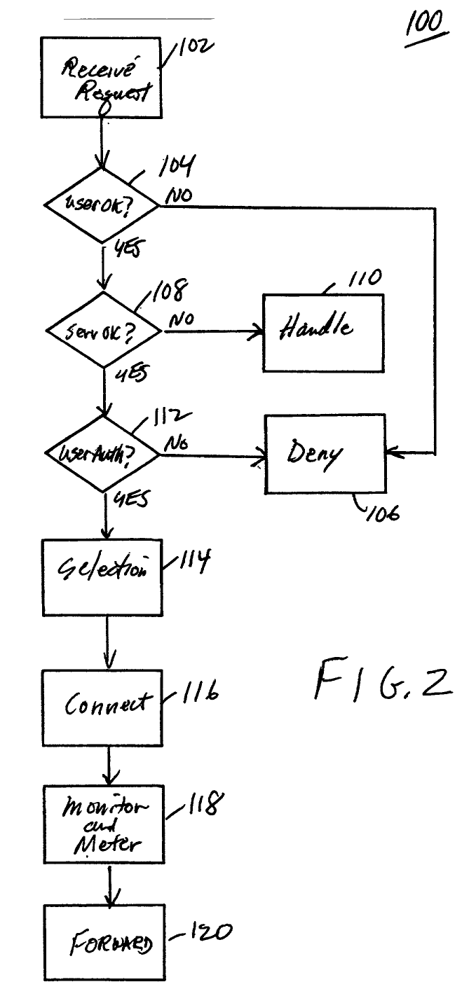

Referring to FIG. 2, a sponsored packet switched data service process 100 includes receiving (102) a request for a packet switched data service. This request typically originates with the user connecting over the air interface to the network 10. The request may also be in response to a push operation by a service sponsor inviting the user to try the sponsor's service. A push operation is one in which the sponsor initiates activity. The process 100 determines (104) whether the user is authorized to access the network 10 for packet switched data services. User class information and location information needed to make later policy decisions about the packet switched data service is collected during the determination (104). If the user is not authorized to access the network 10 the process 100 denies (106) the user request.

If the user is authorized to access the network 10 for packet switched data services, the process 100 determines (108) whether requested service is a sponsored packet switched data service. If the service request is not for a sponsored packet switched data service, the process 100 handles (110) the user request with other service request processes.

If the service request is for a sponsored packet switched data service, the process 100 determines (112) whether the user is authorized to access the specific requested sponsored packet switched data service. If the user is not authorized to access the specific requested packet switched data service, the process 100 denies (106) the user request.

If the user is authorized to access the specific requested packet switched data service, the process 100 selects (114) a service provider for the specific requested switched data service. The selection (114) is made in conjunction with a stored rule base implementing policy decisions of an operator of the network 10 based on one or more factors. Factors may include a user identity, a location of the user, a time of day, a user class, a service provider class, network conditions, pre-agreement rules, and/or governmental regulations. For example, if the operator of network 10 would normally supply specific requested switched data service, the rule base selection preferentially chooses the operator as the service provider.

The selected service provider, i.e., sponsor, identity may be a class, i.e., a subsequently selected service provider, or rules for determining the sponsor from later acquired information. The operator, in the case of where it is providing the service, will be named as the sponsor. If a third party is chosen as the service provider and has agreed to sponsor the service, then it will be identified as the sponsor. The process 100 may use another rule base that implements policy decisions of the operator for selecting the sponsor. In an example, the selection is based on a preagreement between a third party and the operator to be the sponsor or co-sponsor of a particular service.

The process 100 connects (116) the user through SGSN 30, GBN 38, and GGSN 32 to the selected service provider and initiates a packet switched data service session. The process 100 monitors and meters (118) the packet switched data session, gathering, for example, billing and other information generated during the session. The type of billing and other information generated depends upon the type of packet switched data service provided and the sponsor. In an example, the type of information gathered will be a policy decision of the network operator. In the case of a third party sponsor, the policy decision is usually based upon a pre-agreement between the operator and the third party. For example, if a third party service provider is the sponsor of a free packet switched data service, the billing information is gathered for network connection charges that are based on a number of criteria. Additionally, information about the use of the data service may be gathered, so that the provider may charge such expenses to, for example, its marketing and advertising accounts. Similarly, when the service provider is the operator it typically has no out-of-pocket costs, but may need to know network usage and data service usage so can transfer this information to, for example, its marketing and advertising accounts.

During the session, the process 100 may forward charging information Billing System 42 in real time, or in near real time.

When the session is complete, the process 100 transfers (120) the billing and other information to the Billing Node 42. The Billing Node 42 credits to the account(s) of the identified sponsor(s) for payment and information units stored for information transfer. Also, any usage information, as necessary, is reconciled for user records by the billing node 42.

What is claimed is:

1. A method of providing a sponsored packet switched data service comprising:
receiving a request in a wireless network for a sponsored packet switched data service from a user;
determining a sponsor for the requested service in accordance with stored policies;
determining a session billing in accordance with the stored policies;
establishing a session between the user and the sponsor; and
billing the sponsor on completion of the session.

2. The method of claim 1 in which the stored policies includes pre-arrangements between a network provider and sponsors of packet switched data services.

3. The method of claim 1 in which the stored polices include factors.

4. The method of claim 3 in which the factors include a user identity, a user location, a time of day, a user class, a service provider class, network conditions, pre-agreement rules and/or governmental regulations.

5. The method of claim 1 in which the sponsor is a packet switched data service provider.

6. The method of claim 1 in which the sponsor is an operator of the network.

7. The method of claim 1 in which the sponsor is a third party packet switched data service.

8. The method of claim 1 in which the wireless network is a second generation wireless network.

9. The method of claim 1 in which the wireless network is a Global System for Mobile communication (GSM) network.

10. The method of claim 9 in which the GSM network is General Packet Radio System (GPRS) enabled.

11. The method of claim 1 in which the wireless network is a Time Division Multiple Access (TDMA) network.

12. The method of claim 1 in which the wireless network is a Code Division Multiple Access (CDMA) network.

13. The method of claim 1 in which the wireless network is a Universal Mobile Telecommunications System (UMTS) network.

14. The method of claim 1 in which the wireless network is a TETRA network.

15. The method of claim 1 in which the wireless network is a Tetrapol network.

16. The method of claim 1 in which the wireless network is a DECT network.

17. The method of claim 1 in which the wireless network is an AMPS network.

18. The method of claim 1 in which the wireless network is a wireless local area network (WLAN).

19. The method of claim 1 in which the wireless network is a third generation wireless network.

20. A method of providing a sponsored packet switched data service in a General Packet Radio System (GPRS) enabled Global System for Mobile communication (GSM) network comprising:
receiving a request for a sponsored packet switched data service from a user;
determining a sponsor for the requested service in accordance with stored policies;
determining a session billing in accordance with the stored policies;
establishing a session between the user and the sponsor; and
billing the sponsor on completion of the session.

21. The method of claim 20 in which the stored policies includes pre-arrangements between a network provider and sponsors of packet switched data services.

22. The method of claim 20 in which the stored polices include factors.

23. The method of claim 22 in which the factors include a user identity, a user location, a time of day, a user class, a service provider class, network conditions, pre-agreement rules and/or governmental regulations.

24. The method of claim 20 in which the sponsor is a packet switched data service provider.

25. The method of claim 20 in which the sponsor is an operator of the network.

26. The method of claim 20 in which the sponsor is a third party packet switched data service.

27. A method comprising:
in a General Packet Radio System (GPRS) enabled Global System for Mobile Communication (GSM) network, collecting call data records (CDRs) from a Serving GPRS support node in the network;
sending the CDRs to a charging gateway in the network; and
processing the CDRs for packet switched data into a single composite CDR stream in the charging gateway.

28. The method of claim 27 in which collecting further comprises:
collecting CDRs from a GPRS support node.

29. The method of claim 27 in which processing further comprises:
augmenting the CDRs for packet switched data in a billing mediation node.

30. The method of claim 27 in which the single composite CDR stream represents a user session.

31. A method of providing a sponsored packet switched data service comprising:
in a GPRS enabled GSM network, receiving a request for a packet switched data service;
selecting a service provider for the packet switched data service;
connecting a session to the selected service provider;
metering the session; and
generating billing information from the metering.

32. The method of claim 31 in which the request is from a user.

33. The method of claim 32 in which selecting further comprises:
authenticating access for the user to the service provider.

34. The method of claim 33 in which selecting further comprises:
determining whether the request is for the selected service provider.

35. The method of claim 34 in which selecting further comprises:
determining authorization for the user to the selected service.

36. The method of claim 32 metering comprises:
monitoring the session between the user and the selected service provider.
